(19) United States
(12) Patent Application Publication
(10) Pub. No.: US 2006/0041159 A1
(43) Pub. Date: Feb. 23, 2006

(54) Transition metal complexes with proton sponges as ligands

(75) Inventors: Hans-Ulrich Wustefeld, Bottrop (DE); William C. Kaska, Goleta, CA (US); Galen D. Stucky, Goleta, CA (US); Ferdi Schuth, Mullheim an der Ruhr (DE); Bernt Krebs, Munster (DE)

Correspondence Address: NORRIS, MCLAUGHLIN & MARCUS, PA, 875 THIRD AVENUE, 18TH FLOOR, NEW YORK, NY, 10022, US

(73) Assignee: Studiengesellschaft Kohle MbH, Mulheim an der Ruhr (DE)

(21) Appl. No.: 10/470,260

(22) PCT Filed: Jan. 19, 2002
(86) PCT No.: PCT/EP02/00494

§ 371 Date: Jan. 7, 2004

(30) Foreign Application Priority Data
Jan. 25, 2001 (DE) 101 03 244.7

(51) Int. Cl. C07F 15/00

(52) U.S. Cl. 556/136; 546/2

(57) ABSTRACT

Transition metal complexes with quino[7,8-h]quinolines and cyclopentadieno[1,2-h:4,3-h′]diquinolines as proton sponge ligands and a process for their preparation. These complexes are suitable as catalysts, e.g. the palladium complexes for a Heck reaction, as well as for amination and C—H activation reactions. The platinum and palladium complexes are potentially good cytostatic agents.

The present invention relates to novel transition metal complexes with quino[7,8-h]quinoline or derivatives thereof (I) and cyclopentadieno[1,2-h:4,3-h′]diquinoline or derivatives thereof (II) as ligands, a process for their preparation and their use as catalysts for Heck, amination and C—H activation reactions and as cytostatic agents.

Ligands I and II with the substituents R═H and Y═H are known as proton sponges (M. A. Zirnstein, dissertation, Universität Heidelberg, 1989). Proton sponges are characterized by a low nitrogen-nitrogen distance, a high basicity and rather low protonation speed.

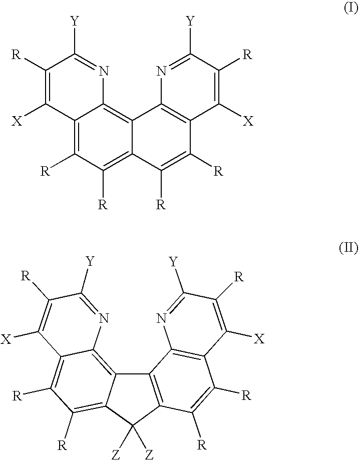

To date, proton sponges, like 1,8-bis(dimethylamino)naphthalene synthesized by R. W. Alder in 1968 (R. W. Alder, P. S. Bowman, W. R. S. Steele and D. R. Winterman, J. Chem. Soc. Chem. Comm. 1968, 723) and quino[7,8-h]quinoline (M. A. Zirnstein, H. A. Staab, Angew. Chem. 1987, 99, 460), have served as auxiliary bases for organic reactions. Transition metal complexes with proton sponges as ligands have not been known to date.

We have now succeeded to prepare the transition metal complexes III and IV according to the invention by the reaction of a precursor complex with ligands I and II, respectively, wherein the precursor complex contains the transition metal M and the substituents L bonded to M, and at least 2 coordination sites of M are occupied by weakly coordinating ligands L, e.g., a solvent, a CO group or a π system, e.g., ethene. The preparation of ligands I and II can be effected in a known way (DE 38 14 213 A1).

The reaction takes place in the presence of an aprotic solvent, e.g., halogenated hydrocarbons, especially dichloromethane or chloroform, or of THF or another chemically stable ether.

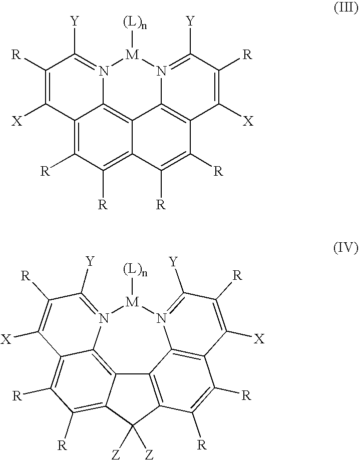

In I, II, III and IV, the following meanings apply: X=hydrogen, halogen, alkoxy, OH, nitro or amino group, wherein the two X substituents may be the same or different; Y=hydrogen, halogen, carboxy, carboxylate, alkyl or functionalized alkyl group, OH or amino group, wherein the two Y substituents may be the same or different and two R substituents may together form part of a ring system; L=any substituent, preferably halogen, alkyl, carbonyl or carboxylate group; R=any substituent, preferably hydrogen, halogen, alkyl and derivatives, aryl and derivatives, sulfonic acid group, carboxylate group and amino group, wherein the substituents R may be the same or different; Z=hydrogen, alkyl or aryl group, wherein the two Z substituents may be the same or different, or the two substituents together are ═O. As the transition metal M, a metal of Periodic Table groups 3, 4, 5, 6, 7, 8, 9, 10, 11 or 12 may be used, the complexes formed having different stabilities, however. Complexes with a metal of groups 7, 8, 9, 10, 11 or 12 are more stable than others.

The complexes according to the invention represent the first stable transition metal complexes with a proton sponge as a ligand.

The formation of metal complexes of formula III is surprising because the extremely low N—N distance in the ligands I (for 4,9-dichloroquino[7,8-h]quinoline: 2.69 Å) and II and the steric hindrance connected therewith do not suggest this. The complexes are characterized by an out-of-plane position of the metal atom and by an extremely high thermal and chemical stability. In this case, “out-of-plane position” means that the complexed metal atom is positioned outside the best plane as defined by the aromatic system. “Best plane” means the plane with the smallest least squares deviation for the distances of all carbon and nitrogen atoms of the ligand. For example, the platinum atom of compound V is positioned at a distance of 1.43 Å, and the rhenium atom of compound VII at a distance of 1.42 Å, from the thus defined plane. This position of the metal atoms, which is extraordinary with respect to the distance from the defined plane, is as yet unique.

In these systems, the stability of the complexes as well as the lability of the ligands of the metal complexes can be adjusted over a wide range by varying the X substituents, since the pK value of the proton sponge ligands can thus be changed by up to 6 units. When the two X substituents are substituted differently, chiral catalysis is possible.

For example, by sterically demanding Y substituents, the metal atom can be shielded. In addition, chiral catalysis is enabled by an unequal substitution by sterically demanding substituents on one side and sterically less demanding substituents on the other side.

The synthesis of a metal complex of the proton sponges I and II was a great challenge because the precursor complexes and the solvent have to meet some requirements due to the high basicity of the ligands and their low N—N distance.

Advantageous properties of potential precursor complexes are:
Part of the ligands of the precursor complex should be labile and not strongly bonded thermodynamically, so that they are easily substituted.
The precursor complex should be stable in basic medium at least for some hours.
Ideally, a weakly complexing solvent occupies one coordination site of the metal atom.

Advantageous properties of the solvent are:
The solvent should not be protic, since the proton sponge is otherwise protonated, which turns it unreactive for complexing attempts due to the strong N—H bond.
Further, the solvent should not contain any weak C—H bond either, if possible, since the proton sponge could abstract its H atom. On the one hand, this would block its coordination sites, and on the other hand, reactive species (carbenes) having a wide variety of possibilities to react would be formed. Mixtures of products would be the consequence.
The solvent should be as stable as possible in a basic medium.
The solvent should coordinate weakly to the metal atom of the precursor.

Examples of transition metal complexes according to the invention include:

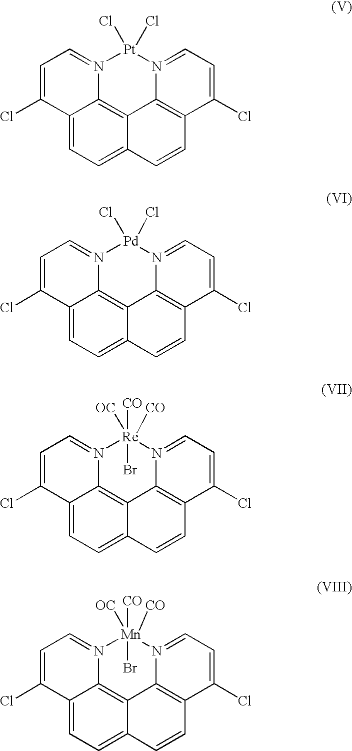

Due to their stability and the out-of-plane position of the metal atom, which might lead to increased reactivity, the transition metal complexes according to the invention are well suited as catalysts for various reactions: Heck reaction (e.g., with compound VI as the catalyst), olefin oxidation, polymerization, e.g., of ethene, as well as for amination reactions.

To date, good Heck catalysts almost exclusively have possessed phosphane-containing ligands, which are sensitive to oxidation and not very stable thermally. Nitrogen-containing ligands in Heck catalysts are known in the form of insufficiently stable complexes, which results in low yields or an increased catalyst consumption (I. P. Beletakaya, A. V. Cheprakov, Chem. Rev. 2000, 100, 3009).

Successful Heck reactions with VI as a catalyst are demonstrated by Examples 5 and 6. The advantage of this phosphane-free system over usual phosphane-containing systems resides in the low tendency of the nitrogen atoms to become oxidized and in the high thermal stability.

Also for amination reactions, predominantly phosphane-containing catalysts have been used to date, which are also little stable thermally, however, and are easily oxidized (J. F. Hartwig, Angew. Chem. 1998, 110, 2154). In contrast, the catalyst systems according to the invention are characterized by a high thermal and chemical stability. In particular, it is advantageous that the catalysts are also stable towards oxidation, because a higher turnover number (TON) can thus be achieved.

For example, this holds for palladium complexes with quino[7,8-h]quinoline ligands which have nitrogen donor ligands, because they are very stable thermally (up to about 380° C.) and are not easily oxidized as well. They are stable in concentrated sulfuric acid.

The stability of the complexes in sulfuric acid shows a potential for application of these compounds as catalysts for C—H activation, especially oxidation of methane to methanol derivatives (R. A. Periana et al., Science 1998, 280, 560). As known from prior experience, the platinum and palladium complexes are good cytostatic agents, analogous to cis-diamminedichloroplatinum(II). By varying the substituents X on the aromatic group, it is possible, on the one hand, to control the lability of the chlorine atoms on the metal atoms. over a wide range, and on the other hand, the out-of-plane position of the metal atom results in an increased reactivity.

The cytostatic properties of the platinum complexes with proton sponges are to be considered by analogy with the properties of the extremely successful cis-diamminedichloroplatinum(II). In the last 30 years, a large number of platinum complexes could be synthesized and examined for their cytostatic activity. By evaluating these data, empirical structure-activity relations could be found (B. Lippert, Chemistry and Biochemistry of a Leading Anticancer Drug, Wiley-VCH, 1999). The platinum complexes claimed here comply with such structure-activity relations, as do many other platinum complexes, but in addition they have two further properties important to activity: The substitution of the groups in 4- and 9-positions of the quino[7,8-h]quinoline enables the lability of the L substituents on the platinum to be adjusted (kinetically) over several orders of magnitude. It is also advantageous that the solubility of these compounds is easily controlled by substituting the protons on the naphthalene skeleton by polar groups, e.g., sulfonic acid groups, without the properties of the reaction center being affected. The lability of the L substituents on the platinum can be varied by various substituents in 4- and 9-positions, whereby the hydrolysis rate and thus usefulness as a cytostatic agent can be controlled.

### EXAMPLES

Examples 1 to 4 state synthetic protocols for the transition metal complexes V to VIII as well as their characterization including the graphical representation of their crystal structures. Examples 5 to 6 show catalysis experiments with VI as the catalyst.

### Example 1

### Synthesis of Pt(chchCl₂)Cl₂

### “chchCl₂” stands for 4,9-dichloroquino[7,8-h]quinoline

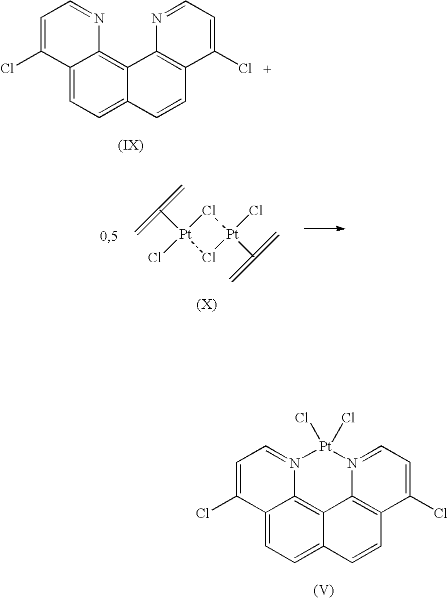

In 20 ml of dried dichloromethane, 59.8 mg (0.2 mmol) of 4,9-dichloroquino[7,8-h]quinoline was dissolved under argon. This solution was added dropwise over 2 h to a boiling solution of 58.8 mg (0.1 mmol) di-(μ-chloro)dichlorobis(ethylene-platinum) X in dichloromethane, and after the addition was complete, the solution was maintained under reflux at the boiling temperature for another hour, then cooled down to room temperature, and the clear yellow solution was filtered. The solution was concentrated to a solvent volume of 15 ml, and the precipitated bright yellow substance was subjected to vacuum filtration. This was followed by washing with 20 ml each of ice-cold dichloromethane and chloroform and recrystallization from dichloromethane.

Characterization:

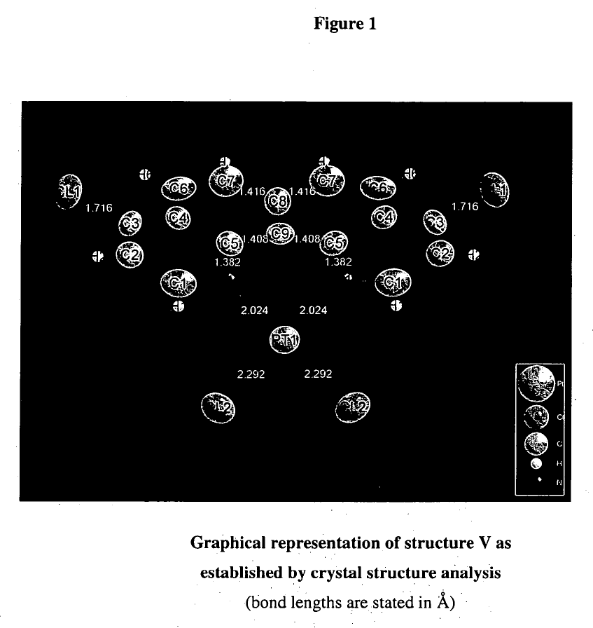

The result of the crystal structure analysis is shown in FIG. 1.

Mass spectrum (EI):

m/z=563 (4.98%, M⁺, isotope pattern for 4Cl), 528 (10.24%, M⁺-Cl, isotope pattern for 3Cl), 492 (6.18%, M⁺-HCl-Cl, isotope pattern for 2Cl), 456 (8.56%, M⁺-2HCl-Cl)

IR spectrum (KBr):

v=3123 (w), 3091 (m), 3060 (m), 3039 (w), 1611 (s), 1575 (s), 1559 (m), 1520 (w), 1478 (s), 1409 (s), 1348 (s), 1221 (s), 1199 (s), 1028 (s), 857 (s), 845 (s), 766 (m), 704 (s), 677 (m)

### Example 2

### Synthesis of Pd(chchCl₂)Cl₂

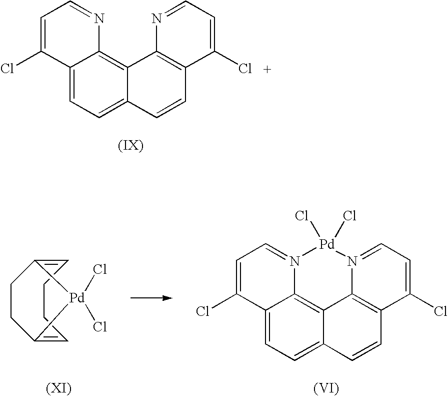

59.8 mg (0.2 mmol) of 4,9-dichloroquino[7,8-h]quinoline was dissolved in 30 ml of a dried mixture of 8:1 dichloromethane/chloroform. Under reflux and under argon, this solution was added dropwise over 1.5 h to a solution of 57.1 mg (0.2 mmol) of cis-dichloro(1,5-cyclooctadiene)palladium XI. After the addition was complete, the solution was heated for another 2 h under reflux. Subsequently, the solution was concentrated to a solvent volume of 20 ml, and 10 ml of dichloromethane was added to the solution. Then, after thorough mixing, the solution was concentrated to a solvent volume of 10 ml. After cooling to room temperature, the precipitated yellow powder was filtered off and washed with 20 ml of ice-cold dichloromethane.

Mass spectrum (EI):

m/z=476 (0.11%, M⁺), 441 (0.23%, M⁺-Cl, isotope pattern for Pd/3Cl), 406 (0.19%, M⁺-2Cl, isotope pattern for Pd/2Cl), 371 (0.10%, M⁺-3Cl)

IR spectrum (KBr):

v=3089 (m), 3060 (m), 2959 (m), 2931 (m), 1707 (m), 1609 (s), 1576 (m), 1516 (m), 1478 (m), 1408 (m), 1348 (m), 1253 (m), 1191 (m), 1026 (s), 855 (s), 847 (s), 768 (m), 704 (m), 678 (w), 632 (w)

### Example 3

### Synthesis of Re(chchCl₂)(CO)₃Br

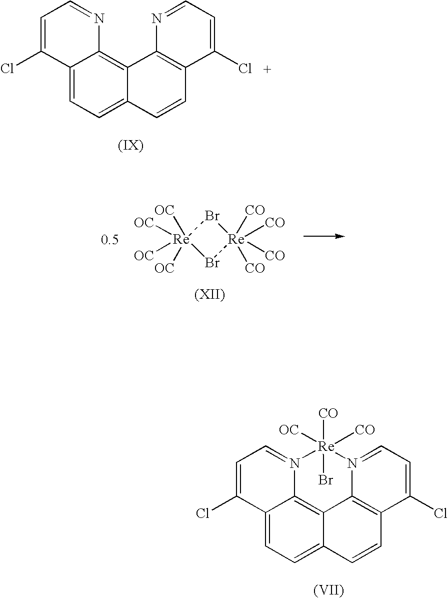

Under argon, 75.6 mg (0.1 mmol) of dimeric tetracarbonylrhenium bromide and 59.8 mg (0.2 mmol) of 4,9-dichloroquino[7,8-h]quinoline were suspended in 50 ml of THF. The mixture was heated under reflux for 5 days under argon. In the course of the first 2 days, the solution changed its color from light brown to orange-red. On the third day, a fine-grained dark orange substance precipitated. After the reaction was complete (5 days), the solution was concentrated to 10 ml and cooled down to room temperature. The product was subjected to vacuum filtration under argon and washed with 10 ml of ice-cold THF and dichloromethane. It was recrystallized from 20 ml of THF under argon, subjected to vacuum filtration and washed with THF, hexane and dichloromethane.

Characterization:

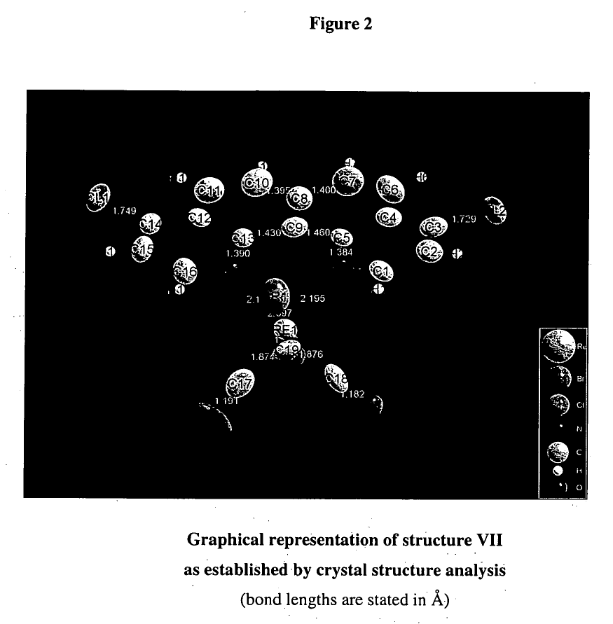

The result of the crystal structure analysis is shown in FIG. 2.

Mass spectrum (EI):

m/z=648 (51.71%, M⁺, corresponding isotope pattern), 620 (31.18%, M⁺-CO, corresponding isotope pattern), 592 (94.95%, M⁺-2CO, corresponding isotope pattern), 564 (28.06%, M⁺-3CO)

Exact mass (EI) [amu]: 647.866 (calc.: 647.8655)

IR spectrum (KBr):

v=2962 (s), 2927 (s), 2854 (m), 2020 (s, v_{C-O}), 1920 (s, v_{C-O}), 1890 (s, v_{C-O}), 1730 (w), 1614 (w), 1577 (w), 1553 (w), 1467 (w), 1023 (s), 864 (m), 843 (m), 701 (m)

### Example 4

### Synthesis of Mn(chchCl₂)(CO)₃Br

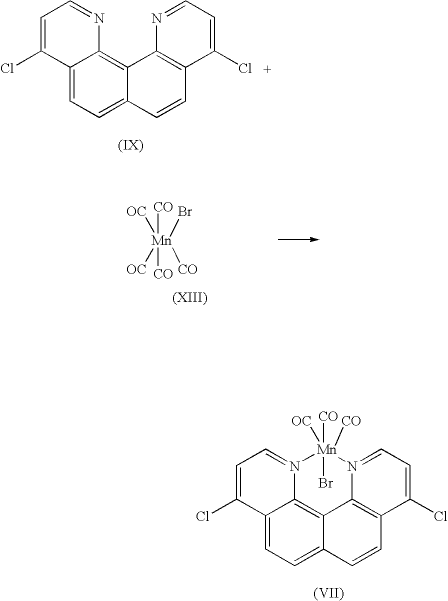

In 30 ml of THF, 29.9 mg (0.1 mmol) of 4,9-dichloroquino[7,8-h]quinoline and 27.5 mg (0.1 mmol) of pentacarbonylmanganese(I) bromide were suspended under argon. The solution was heated under reflux for 7 days. A white, grayish powder precipitated and was processed like compound VI.

Mass spectrum (EI): m/z=432 (0.61%, M⁺-3CO)

IR spectrum (KBr):

v=3064 (w), 2963 (m), 2022 (m, v_{C-O}), 1933 (m, v_{C-O}), 1914 (m, v_{C-O}), 1608 (s), 1579 (s), 1550 (s), 1509 (s), 1480 (s), 1407 (s), 1021 (s), 849 (m), 839 (m), 769 (m), 695 (m) 683 (w), 633 (w)

### Example 5

Heck reaction and yields with VI as a catalyst and, for comparison, a reaction performed with the standard Heck catalyst palladium acetate/triphenylphosphane:

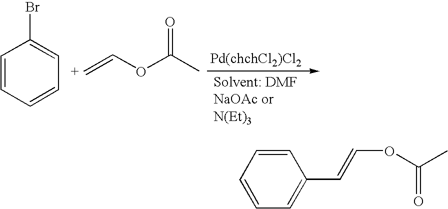

Reaction Conditions:

| | Yield of trans | Yield of cis | Total yield |
|---|---|---|---|
| Catalyst system | product [%] | product [%] | [%] |
| Pd(chchCl₂)Cl₂ | 52.1 | 3.6 | 55.7 |
| Sodium acetate | | | |
| Palladium acetate/4 PPh₃ | 11.8 | 0.6 | 12.4 |
| Sodium acetate | | | |

### Example 6

Heck reaction and yields with VI as a catalyst and, for comparison, a reaction performed with the standard Heck catalyst palladium acetate/triphenylphosphane:

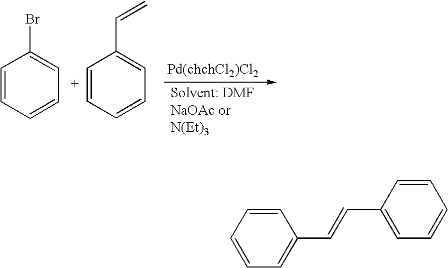

Reaction Conditions:

| | Yield of trans | Yield of cis | Total yield |
|---|---|---|---|
| Catalyst system | product [%] | product [%] | [%] |
| Pd(chchCl₂)Cl₂ | 62.1 | 3.3 | 65.4 |
| Sodium acetate | | | |
| Palladium acetate/4 PPh₃ | 11.1 | 2.1 | 13.2 |
| Sodium acetate | | | |
| Pd(chchCl₂)Cl₂ | 37.8 | 4.3 | 42.1 |
| Triethylamine | | | |
| Palladium acetate/4 PPh₃ | 22.1 | 4.4 | 26.5 |
| Triethylamine | | | |

1. A transition metal complex of formula III or IV: 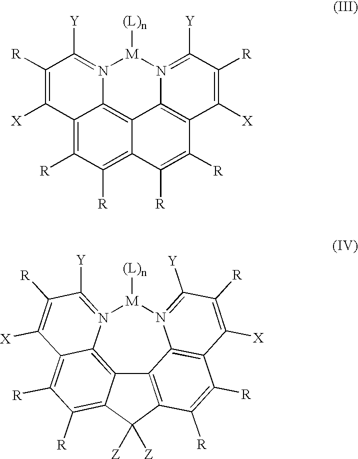
wherein
X=halogen, hydrogen, alkoxy, OH, nitro or amino group, wherein the two X substituents may be the same or different;
Y=hydrogen, carboxy, carboxylate, alkyl or functionalized alkyl group, 011- or amino group, wherein the two Y substituents may by the same or different;
L=any ligand, wherein the L, substituents may be the same or different;
M=a metal selected from Periodic Table groups 3, 4, 5, 6, 7, 8, 9, 10, 11 or 12;
Z=hydrogen, alkyl or aryl group, wherein the two Z substituents may be the same or different, or the two substituents together are ═O.
R=any substituent, wherein the substituents R may be the same or different, and two R substituents may together form part of a ring system;
n=from 0 to 6.

2. The transition metal complex according to claim 1, wherein M is a metal selected from. Periodic Table groups 7, 8, 9, 10, 11 or 12.

3. The transition metal complex according to claim 1, wherein L=halogen, alkyl, carbonyl or carboxy late group.

4. The transition metal complex according to claim 1, having one of formulas V, VI, VII or VIII:

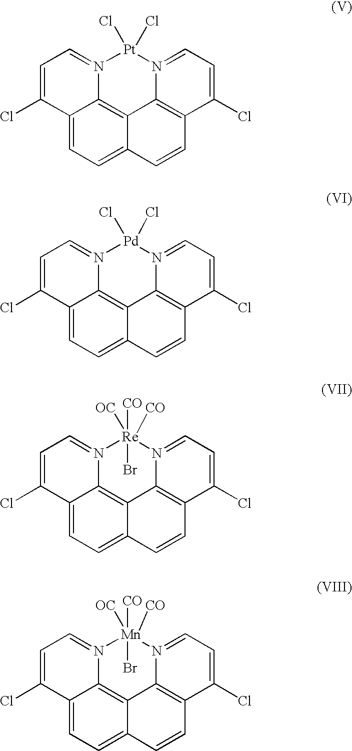

5. A process for preparing a transition metal complex of claim 1 by reacting ligand I or II with a precursor complex in the presence of a solvent, wherein a precursor complex is employed which contains the transition metal M and the substituents L bonded to M and in which at least two coordination sites of M are occupied by weekly coordinating ligands;
wherein
X=halogen, hydrogen, alkoxy or amino group, nitro or OH group, wherein the two X substituents may be the same or different;
Y=hydrogen, carboxy, carboxylate, alkyl or functionalized alkyl group, OH group or amino group, wherein the two Y substituents may be the same or different;
L=any ligand, or halogen, alkyl, carbonyl or carboxylate group, wherein the L substituents may be the same or different;
M=a metal selected from Periodic Table groups 3, 4, 5, 6, 7, 8, 9, 10, 11 or 12,
Z=hydrogen, alkyl or aryl group, wherein the two Z substituents may be the same or different or may be ═O;
R=any substituent, wherein the substituents R may be the same or different, and two R substituents may together form part of a ring system;
n=from 0 to 6:

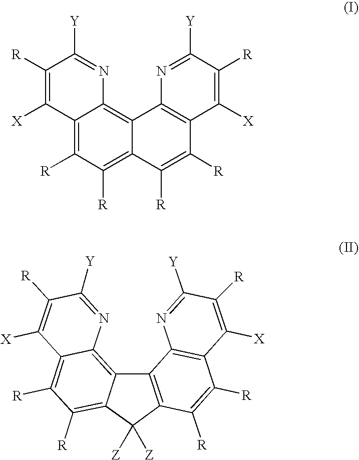

6. The process according to claim 5, wherein the solvent, a CO group or a π system are used as said weakly coordinating ligands.

7. The process according to claim 5, wherein halogenated hydrocarbons or THF are employed as said solvent.

8. The process according to claim 7, wherein dichloromethane or chloroform arc employed as said solvent.

9. The process according to claim 5, wherein a transition metal carbonyl halide is employed as said precursor complex.

10. The process according to claim 9, wherein di-(μ-chloro)dichlorobis(ethylene-platinum(II)), cis-dichloro(1,5-cyclooctadiene)palladium(II), dimeric tetracarbonylrhenium(I) bromide or pentacarbonylmanganese(I) bromide is employed as said precursor complex.

11. A process in the form of a “Heck reaction” for the catalyzed preparation of olefinated aromatics or heteroaromatics, characterized in that transition metal complexes of claim 1 with Pd as said transition metal M are employed as catalysts.

12. A process for catalytic amination, characterized in that a transition metal complex of claim 1 with Pd or Pt as said transition metal M are employed as a catalyst.

13. A process for catalytic C—H activation characterized in that a transition metal complex of claim 1 is employed as a catalyst.

14. The process according to claim 13, wherein methanol derivatives are prepared by the oxidation of methane.

15. Method of exerting a cytostatic effect comprising administering to a patient in need thereof an effective amount therefor of the transition metal complexes of claim 1.

16. Method according to claim 15, wherein M in complex III or IV is platinum.

17. Method according to claim 16, wherein the effectiveness or selectivity of the transition metal complex as a cytostatic agent is adjusted by selecting the X substituents in complex III or IV.

18. The transition metal complex according to claim 1, wherein each R is a substituent independently selected from the group consisting of hydrogen, halogen, alkyl and derivatives, aryl and derivatives, sulfonic acid group, carboxylate group and amino group.

19. The process according to claim 5, wherein each R is a substituent independently selected from the group consisting of hydrogen, halogen, alkyl and derivatives, aryl and derivatives, sulfonic acid group, carboxylate group and amino group.

20. The transition metal complex according to claim 1, wherein each L is a ligand independently selected from the group consisting of halogen, alkyl, carbonyl and carboxylate group; and R is a substituent independently selected from the group consisting of hydrogen, halogen, alkyl and derivatives, aryl and derivatives, sulfonic acid group, carboxylate group and amino group.

21. The process according to claim 5, wherein each L is a ligand independently selected from the group consisting of halogen, alkyl, carbonyl and carboxylate group; and R is a substituent independently selected from the group consisting of hydrogen, halogen, alkyl and derivatives, aryl and derivatives, sulfonic acid group, carboxylate group and amino group.
